(19) United States
(12) Patent Application Publication
(10) Pub. No.: US 2008/0264491 A1
(43) Pub. Date: Oct. 30, 2008

(54) Fluid multiplexer for capillary column gas chromatography

(76) Inventors: Matthew S. Klee, Wilmington, DE (US); Wesley Miles Norman, Landenberg, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/796,495

(22) Filed: Apr. 27, 2007

(51) Int. Cl. G05D 11/02; F17D 3/18

(52) U.S. Cl. 137/9; 137/89; 137/99

(57) ABSTRACT

A fluid multiplexer includes a manifold having a plurality of fluid conduits formed therein, a fluid input and a plurality of fluid connection points located on the manifold and fluidically coupled together via the fluid conduits, and a flow control module coupled to the fluid connection points, the flow control module configured to provide a plurality of blocking flows to the manifold to control the flow of a primary fluid through the fluid conduits.

### BACKGROUND

Gas chromatography (GC) is used to separate and detect different compounds in a sample mixture. One of the common methods for performing gas chromatography uses open tubular capillary columns to separate the sample gas into its constituent compounds. The interior surface of the capillary column is typically an inert material that is coated with, or has adsorbed onto it, a material referred to as the “stationary phase.” The sample mixture is introduced into the capillary column through a sample inlet device preferably in what is referred to as a “plug” and is transported through the capillary column using an inert carrier gas, which is referred to as the “mobile phase.” When the sample gas encounters the stationary phase, the different components in the sample gas are attracted differently to the stationary phase, causing the different components in the sample gas to travel through the stationary phase at different speeds. Separation occurs by the differential retardation of sample components through interaction with the stationary phase as they are driven through the column by the mobile phase. Each sample component will have a characteristic delay between the time it was introduced into the chromatographic system and the time that it is detected after it elutes from the separation column. This characteristic time is called its “retention time.” Some minimum amount of difference in retention time allows differentiation of sample components chromatographically. One or more detectors at the exit of the capillary column detect the different compounds when they elute from the capillary column and provide a signal proportional to amount of the sample component. The different components are shown as “peaks” on a chromatogram where the height and area beneath the peak corresponds to the amount of the compound. In typical capillary gas chromatography, peak widths are on the order of a few seconds.

When selecting a suitable stationary phase for best separation of expected components in a specific sample type, one must screen several different column types to see which one is most suitable. The effort required to reconfigure a GC instrument can be time consuming, especially if air sensitive columns and/or detectors are used. For example, a mass spectrometer must be cooled and vented prior to installation of a new column. This process can take several hours each time a column is changed. The process of screening several column types during method development and validation can require several days to reconfigure the instrument. It would be desirable to have a configuration that allows automated stream selection to facilitate screening of columns without having to reconfigure the instrument. Such a capability would also allow unattended acquisition of data for evaluation of determination of suitability of each column for the sample at hand.

In other types of chromatography, such as liquid chromatography, instruments are run at room temperature and characteristics of the technology allow relatively simple application of rotary valves to switch a sample stream between multiple potential columns. In liquid chromatography, the mobile phase is a liquid solvent that can effectively prevent sample components from adsorbing to the polyimide valve rotors. However, due to the high temperatures involved with gas chromatography, the use of inert gas mobile phase, and the narrow peak widths, the typical rotary valves with polyimide rotors are problematic when using them to select between capillary columns in a manner analogous to liquid chromatography.

In some GC analysis applications, it is desirable to use multiple capillary columns having different stationary phase or different characteristics to more completely analyze a sample. The coupling of columns of different stationary phase types is commonly termed multidimensional chromatography. To transfer a specific portion of the eluent from a primary capillary column to a secondary one is often called heartcutting.

In order to circumvent the problems of using rotary valves for heartcutting applications, a prior art flow switching device, referred to as a “Deans switch” is sometimes used. FIG. 1 is a schematic diagram conceptually illustrating a Deans switch. The brief explanation of a Deans switch is provided as an introduction to fluid flow control. The device 100 includes a fluid conduit 112 coupled to common ends of fluid conduits 114 and 116. The fluid conduits 114 and 116 are coupled at their other ends to fluid conduits 118 and 122, respectively. Additionally, these ends of fluid conduits 114 and 116 are respectively coupled to fluid conduits 124 and 126. A primary flow is indicated using arrow 128 and a directing flow is indicated using arrows 132. In this example, the primary flow travels through the fluid conduit 112 until it reaches the tee formed at the intersection of fluid conduits 112, 114 and 116. A directing flow 132 is introduced into the fluid conduit 124. A portion of the directing flow 132 travels through the fluid conduit 114 and a portion of the directing flow travels through the fluid conduit 118. The portion of the directing flow 132 that travels through the fluid conduit 114 directs the primary flow 128 into the fluid conduit 116 and to the fluid conduit 122. In this example, there is no directing flow in the fluid conduit 126.

To switch the primary flow 128 to the fluid conduit 114, the directing flow 132 is shut off and a directing flow is introduced to the fluid conduit 126. This causes the primary flow 128 to travel from the fluid conduit 112 into the fluid conduits 114 and 118. While a Deans switch can be used to select between two streams, selecting more than two streams is complicated to set up and balance, unwieldy due to excess tubing and connections, subject to additional leaks due to additional connections, and in general quite difficult to implement. Also, the pressure and flow balancing required is somewhat burdensome. Hence a convenient and rugged means of selecting between multiple streams is desirable.

### SUMMARY

According to an embodiment, a fluid multiplexer comprises a manifold having a plurality of fluid conduits formed therein, a primary fluid input and a plurality of controlling fluid connection points located on the manifold and fluidically coupled together via the fluid conduits, and a flow control module coupled to the controlling fluid connection points, the flow control module configured to provide a plurality of blocking flows to the manifold to control the flow of a primary fluid through the fluid conduits.

Other embodiments of the fluid multiplexer will be discussed with reference to the figures and to the detailed description of the preferred embodiments.

### BRIEF DESCRIPTION OF THE FIGURES

The invention will be described by way of example, in the description of exemplary embodiments, with particular reference to the accompanying figures.

FIG. 1 is a schematic diagram conceptually illustrating a prior art flow switching device, referred to as a “Deans switch.”

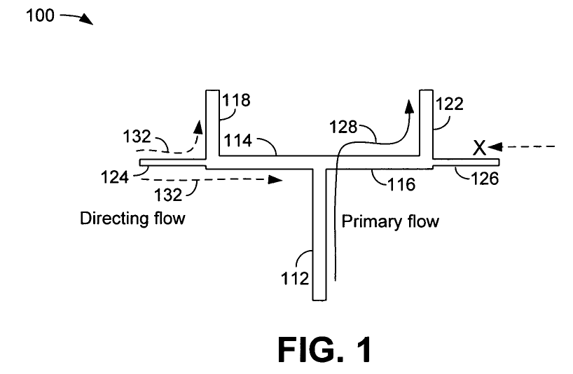

FIG. 2 is a schematic diagram illustrating an embodiment of a fluid multiplexer for capillary column gas chromatography.

FIG. 3 is a schematic diagram illustrating a cross-section of the manifold of FIG. 2.

FIG. 4A is a schematic diagram illustrating an alternative embodiment of a fluid multiplexer.

FIG. 4B is a schematic diagram illustrating a three layer manifold.

FIG. 5 is a block diagram illustrating a simplified gas chromatograph, which is one possible device in which the fluid multiplexer may be implemented.

FIG. 6 is a block diagram illustrating an embodiment of the control processor of FIG. 3.

FIG. 7 is a flow chart illustrating the operation of an embodiment of the fluid multiplexer as applied to a chromatographic analysis having a plurality capillary columns.

### DETAILED DESCRIPTION

While described below as used in a gas chromatograph, the fluid multiplexer for capillary column gas chromatography can be used in any analysis application where it is desirable to control the flow of a fluid from a source to two or more fluid conduits As used herein, the term flow is intended to include forms of mass flow, programmed mass flow, or volumetric flow and/or forms of linear velocity such as programmed linear velocity, average linear velocity, inlet, outlet, or instantaneous linear velocity through a fluid conduit.

The term constant flow, as used herein defines a subset of possible flow control that can be accomplished. In one embodiment, the term “constant flow” defines a mode of flow control wherein constant mass flow is maintained throughout a chromatographic run even as oven temperature is changing. This constant mass flow is also directly related to constant instantaneous velocity (linear velocity as measured at a specific point on along a column). In other embodiments, the term “constant flow” may mean constant average linear velocity, which is different than constant mass flow.

In some chromatographic analysis applications, it is desirable to use at least two columns and transfer the elutant from a first column to a second column for improved results. This type of chromatography is generally referred to as multi-dimensional chromatography. In multi-dimensional chromatography, it is desirable to have the ability to individually control the flow of the material through the two, or more, columns.

As will be described below, the fluid multiplexer for capillary column gas chromatography can be used to direct the flow from a source to a number of different destinations. The source may include a sample introduced through an inlet device of a gas chromatograph or may be another capillary column or conduit. The destinations for the flow may be a number of capillary columns or conduits, or a combination of capillary columns and conduits. The conduits may lead to a variety of elements including detectors.

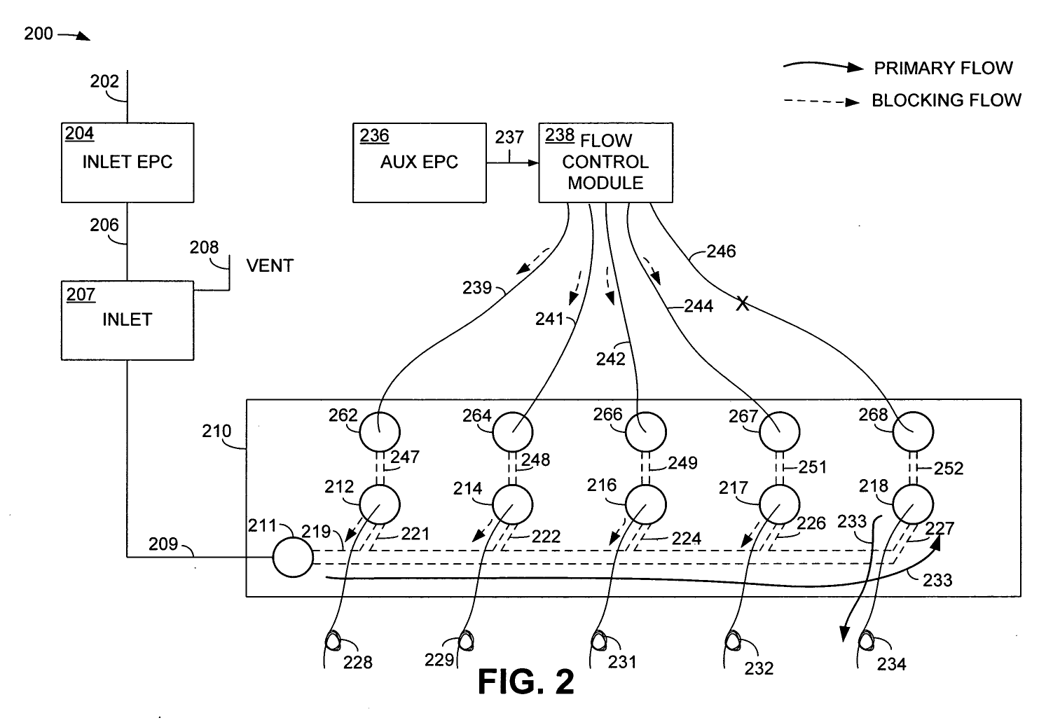

FIG. 2 is a schematic diagram illustrating an embodiment of a fluid multiplexer for capillary column gas chromatography. The fluid multiplexer 200 comprises an inlet pneumatic control element, which in this example is illustrated as an inlet electronic pneumatic control (EPC) element 204. However, a manual controller may be substituted for the inlet EPC element 204. The inlet EPC element 204 provides pressure and/or flow control. The inlet EPC is connected to an inlet 207 via connection 206. The inlet 207 provides a means of passing a gaseous sample to conduit 209. The gaseous sample is then driven by inlet flow through conduit 209 to a manifold 210. In an embodiment, the manifold 210 can be a planar laminate structure having fluid conduits formed therein. As an example, the manifold 210 can be fabricated as described in commonly owned U.S. Pat. No. 6,966,212, entitled “Focusing device based on bonded plate structures.” However, the manifold 210 can be formed using other methods. For example, the manifold 210 can be formed from metal, glass, ceramic, silicon, polymer, or any other material that can be fabricated into a structure in which fluid passages can be formed. Alternatively, the manifold 210 can be any structure having the characteristics described below.

In this example, the manifold 210 includes fluid conduits 219, 221, 222, 224, 226 and 227. The sample gas introduced via conduit 209 is supplied to a primary input 211 located on the manifold 210. The fluid conduit 219 is fluidically coupled to the primary input 211. In this example, the fluid (a sample gas transported by a flowing inert gas) is referred to as the primary fluid having a primary flow, which flows through the fluid conduit 219. The fluid conduits 221, 222, 224, 226 and 227 are all fluidically coupled to the fluid conduit 219.

The manifold 210 also includes a plurality of controlling fluid connection points. The controlling fluid connection points 212, 214, 216, 217 and 218 are fluidically coupled to the fluid conduits 221, 222, 224, 226 and 227, respectively. In this example, a chromatographic capillary column is coupled to each controlling fluid connection point on the manifold 210. However, other fluid conduits may be connected to the controlling fluid connection point on the manifold 210. Capillary column 228 is coupled to the controlling fluid connection point 212, capillary column 229 is coupled to the controlling fluid connection point 214, capillary column 231 is coupled to the controlling fluid connection point 216, capillary column 232 is coupled to the controlling fluid connection point 217 and capillary column 234 is coupled to the controlling fluid connection point 218. In this example, the capillary columns 228, 229, 231, 232 and 234 may have different characteristics that provide different levels of chromatographic separation to a sample.

The manifold 210 also includes an additional plurality of controlling fluid connection points 262, 264, 266, 267 and 268, which are fluidically coupled to the controlling fluid connection points 212, 214, 216, 217 and 218 via fluid conduits 247, 248, 249, 251 and 252, respectively. The fluid conduits 247, 248, 249, 251 and 252 are similar to and can be formed in a similar manner as fluid conduits 221, 222, 224, 226 and 227.

The fluid multiplexer 200 also includes an auxiliary pneumatic control element, which in this example, is an electronic pneumatic control (EPC) element 236. However, a manual controller may be substituted for the auxiliary EPC element 236. The auxiliary EPC element 236 is coupled to a flow control module 238 via connection 237. However, the auxiliary EPC element 236 may alternatively be integrated into the flow control module 238. The flow control module 238 can be any device that can switch the flow of a fluid on and off, and is typically a valve. In an embodiment, a clean carrier gas is provided to the flow control module 238 via the auxiliary EPC 236 and fluid conduit 237 and the flow control module 238 determines to which of a number of blocking flow paths the flow of clean carrier gas will be directed. The carrier gas is typically a gas with favorable chromatographic characteristics such as, for example, nitrogen, helium, hydrogen, as known in the art. In this example, the blocking flow paths 239, 241, 242, 244 and 246 are fluidically coupled to fluid connection points 262, 264, 266, 267 and 268. The fluid connection points 262, 264, 266, 267 and 268 are fluidically coupled to the fluid connection points 212, 214, 216, 217 and 218, respectively, through conduits 247, 248, 249, 251, and 252. In an embodiment, the flow control module 238 can be a rotary valve or any other mechanism for switching fluid flow on and off. In accordance with an embodiment of the fluid multiplexer 200, the flow control module 238 directs a flow of clean carrier gas, referred to herein as a “blocking flow,” to all but one of the fluid connection points 212, 214, 216, 217 and 218.

As an example, the flow of the primary fluid is illustrated using the heavy arrow 233. The primary fluid enters the manifold 210 through the primary input 211, and then enters the fluid conduit 219. In this example, a blocking flow provided by the flow control module 238 is present in the blocking flow paths 239, 241, 242 and 244, and thereby present in the fluid connection points 212, 214, 216 and 217, and in the fluid conduits 221, 222, 224 and 226. The blocking flow is shown using the dashed arrows. As the primary flow 233 in the fluid conduit 219 encounters the blocking flow in the fluid conduit 221, the primary flow 233 does not travel into the fluid conduit 221, but instead continues flowing through the fluid conduit 219 toward the fluid conduit 222. Similarly, when the primary flow 233 encounters the blocking flow in the fluid conduit 222, the primary flow 233 continues in the fluid conduit 219 toward the fluid conduit 224. A similar result occurs when the primary flow 233 encounters the blocking flow in the fluid conduit 224 and in the fluid conduit 226. However, and in accordance with the fluid multiplexer 200, when the primary flow 233 approaches the fluid conduit 227, there is no blocking flow in the fluid conduit 227. Without the blocking flow in the fluid conduit 227, the primary flow 233 travels into the fluid conduit 227, and travels through the fluid connection point 218 and into the column 234. Since all conduits are connected in common, the pressure established by the auxiliary EPC 236 is also present at each of the controlling fluid connection points (212, 214, 216, 217, 218) and therefore dictates the flow rate of gas through each column based on its dimensions, temperature and carrier gas type. As such, the pressure of the auxiliary EPC 236 provides a means of establishing the desired flow rates through the columns 228, 229, 231, 232 and 234.

In this manner, the flow control module 238 and the manifold 210 can switch the primary flow 233 to any of a number of different output paths, illustrated in this example using chromatographic capillary columns, by using a clean carrier gas to provide a blocking flow to all fluid conduits except the fluid conduit in which it is desired to direct the primary flow. Switching the primary flow 233 from one fluid conduit to another is accomplished by deactivating at least one of the active blocking flows and activating an inactive blocking flow to switch the primary flow to the fluid conduit that does not have a blocking flow. While accomplishing this switching, the flow control module 238 can remain outside of the oven (not shown in FIG. 2) in which the chromatographic capillary columns are located. Further, the flow control module 238 encounters only clean carrier gas, and therefore has no sample gas traveling through it. This minimizes corruption of the sample gas in terms of time and contamination, adsorption and carry-over and minimizes wear on the flow control module 238, thus increasing lifetime and reliability, and provides a clean and seamless switching technique. In this manner, the flow control module 238 is not likely to be exposed to sample gas.

The fluid multiplexer 200 can also provide column-to-column switching during a chromatographic run by providing a single switching point to a plurality of different paths.

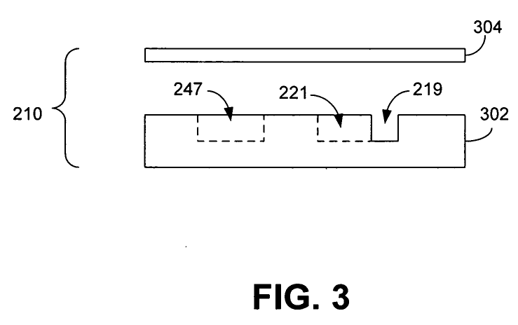

FIG. 3 is a schematic diagram illustrating a cross-section of the manifold 210 of FIG. 2. The manifold 210 comprises a first portion 302 and a second portion 304. In this example, the first portion 302 includes features 219, 221 and 247 formed therein. In this example, the features 219, 221 and 247 correspond to the fluid conduits 219, 221 and 247 shown in FIG. 2. In this example, the second portion 304 is attached to the first portion 302. The second portion 304 can be attached to the first portion 302 in a number of different ways. For example, the second portion 304 can be attached to the first portion 302 by diffusion bonding as described in commonly owned U.S. Pat. No. 6,966,212, entitled “Focusing device based on bonded plate structures.” However, the second portion 304 can be attached to the first portion 302 using various welding or other adhesion techniques. It should be mentioned that while the features 219, 221 and 247 are depicted in FIG. 3 as being part of the first portion of 302, the features 219, 221 and 247 may alternatively be part of the second portion 304.

In this example, the first portion 302 and the second portion 304 are formed from metal. However, the first portion 302 and the second portion 304 can be formed from other materials including, but not limited to, glass, ceramic, silicon, polymer, or any other material in which fluid conduits can be formed. Further, the functionality of the manifold 210 can be provided by a non-planar fluid coupling, so long as the fluid conduits 219, 221 and 247 can be formed, or otherwise provided therein. It should be noted that multiple layers of paths could also be employed.

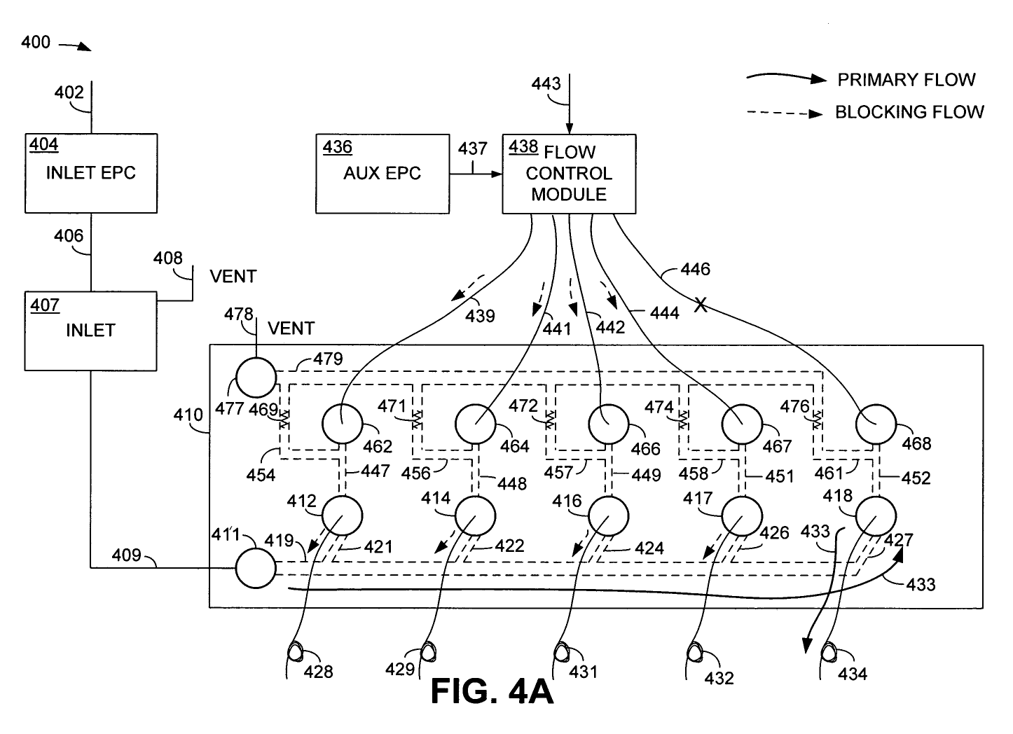

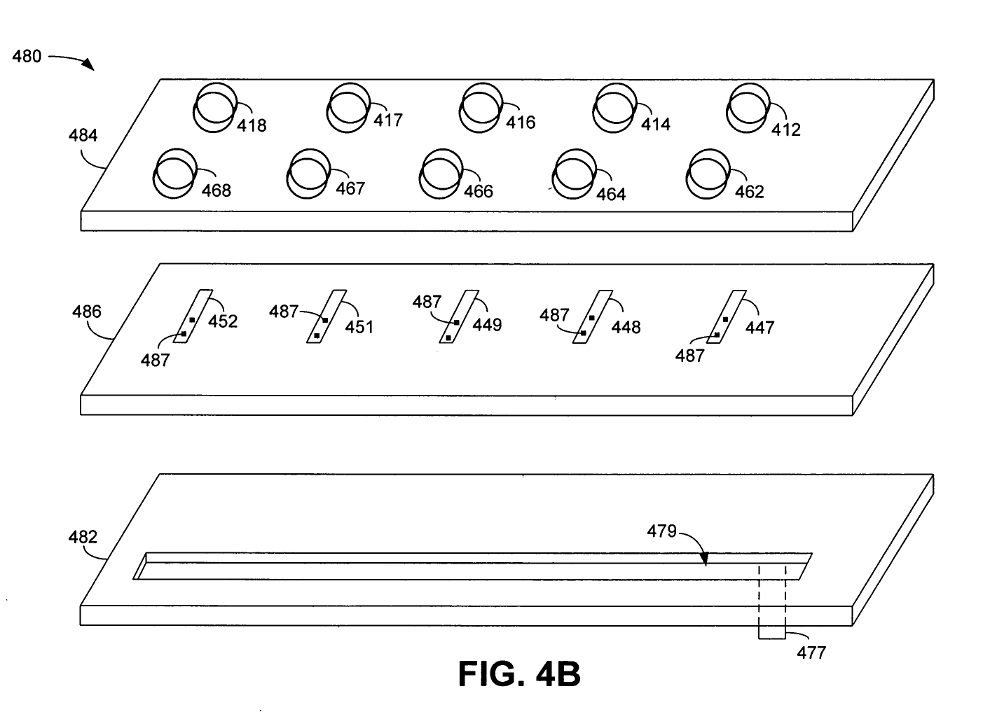

FIG. 4A is a schematic diagram illustrating an alternative embodiment of a fluid multiplexer. The fluid multiplexer 400 is similar to the fluid multiplexer 200 described in FIG. 2. Accordingly, similar elements are similarly numbered using the convention 4XX to denote the elements shown as 2XX in FIG. 2. Accordingly, description of the elements described previously in FIG. 2 will not be repeated.

The controlling fluid connection point 412 is fluidically coupled to the controlling fluid connection point 462 via fluid conduit 447. Similarly, the controlling fluid connection point 414 is fluidically coupled to the controlling fluid connection point 464 via fluid conduit 448; the controlling fluid connection point 416 is fluidically coupled to the controlling fluid connection point 466 via fluid conduit 449; the controlling fluid connection point 417 is fluidically coupled to the controlling fluid connection point 467 via fluid conduit 451; and the controlling fluid connection point 418 is fluidically coupled to the controlling fluid connection point 468 via fluid conduit 452. The fluid conduits 447, 448, 449, 451 and 452 are formed in the manifold 410 as described above with respect to the manifold 210.

A fluid connection point 477 is coupled to the manifold 410 and is also coupled to a vent path 478. A fluid conduit 479 is also coupled to the fluid connection point 477. The fluid conduit 479 is coupled to each of the fluid conduits 447, 448, 449, 451 and 452 via fluid conduits 454, 456, 457, 458 and 461, respectively. The fluid conduit 454 includes a restrictor 469, the fluid conduit 456 includes a restrictor 471, the fluid conduit 457 includes a restrictor 472, the fluid conduit 458 includes a restrictor 474 and the fluid conduit to 461 includes a restrictor 476. The restrictors 469, 471, 472, 474 and 476 may be separate devices located in the respective fluid conduits, or the fluid conduits may include integrated features that function as the restrictors. In this example, the fluid conduits 454, 456, 457, 458, 461 and 479 provide a bleed path for the fluid conduits 447, 448, 449, 451 and 452, respectively. The fluid conduit 479 and the fluid connection point 477 provide a vent path out of the manifold 410. The restrictors provide a small bleed of the flow from the fluid conduits 447, 448, 449, 451 and 452 to the vent 478. The function of the bleed flows is to improve pneumatic switching time, the speed at which flow direction changes, and to minimize peak distortion. The restrictors can be formed in many ways. In this embodiment, the dimensions of the conduits 454, 456, 457, 458, 461 and 479 are sized to yield the appropriate restriction.

In another embodiment, precision ablated holes in the bottom of the conduits 447, 448, 449, 451 and 452 lead to fluid conduit 479 positioned underneath in a separate layer, providing the desired restriction for the bleed path to vent. An example of such a structure is shown in FIG. 4B.

FIG. 4B is a schematic diagram illustrating a simplified three layer manifold. The manifold 480 comprises a first portion 482, a second portion 484 and a third portion 486. The first portion 482 includes the fluid conduit 479 and the fluid connection point 477. The second portion 484 includes the controlling fluid connection points 412, 414, 416, 417, 418, 462, 464, 466, 467 and 468. The third portion 486 includes fluid conduits shown in FIGS. 2 and 4A, and also includes small holes 487 formed in the fluid conduits 447, 448, 449, 451 and 452 to fluidically connect the fluid conduits 447, 448, 449, 451 and 452 to the fluid conduit 479. The holes 487 provide a vent path to the fluid conduit 479. The holes 487 may be formed in a variety of way, including, but not limited to laser ablation, drilling and other techniques.

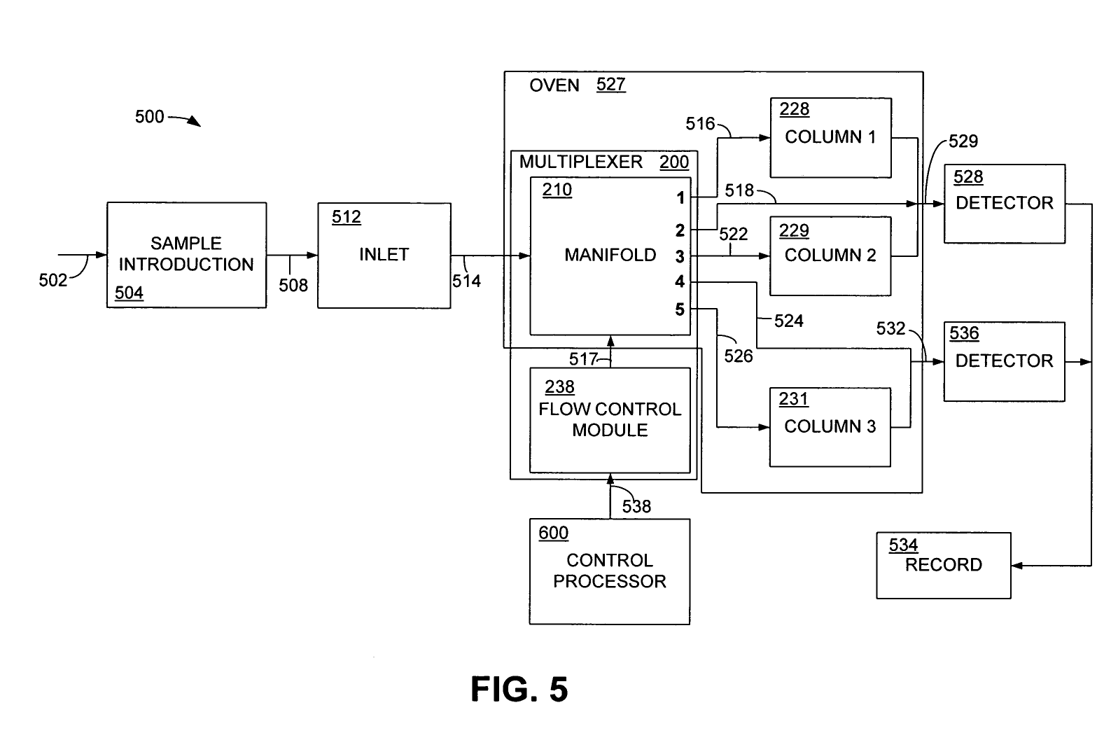

FIG. 5 is a block diagram illustrating a simplified gas chromatograph 500, which is one possible device in which the embodiments of the fluid multiplexer may be implemented. The gas chromatograph 500 includes a means of introducing a sample. A sample can be introduced via any of several devices known to those skilled in the art. For example, a sample may be introduced via a sample valve 504 which receives a gaseous sample of material to be analyzed via connection 502 and provides the sample via connection 508 to the inlet 512 of a gas chromatograph. The inlet 512 is connected to a fluid multiplexer 200 via fluid conduit 514. A control processor 600 can be coupled to the flow control module 238, via connection 538. The flow control module is coupled to the manifold 210 as described above in FIGS. 2 and 4 to control the operation of the fluid multiplexer 200 and the chromatograph 500.

As described above, the manifold 210 can be coupled to a number of different elements. For example, as shown in FIGS. 2 and 4, the fluid multiplexer can be coupled to a plurality of capillary columns. In this example, and for ease of illustration, the fluid multiplexer 200 is coupled to first capillary column 228 via fluid conduit 516, to a second capillary column 229 via fluid conduit 522 and to a third capillary column 231 via fluid conduit 526. The manifold 210 is also coupled to a first detector 528 via fluid conduits 518 and 529 and to a second detector 536 via fluid conduits 524 and 532. The capillary columns 228, 229 and 231 and the manifold 210 are located in a chromatographic oven 527. The chromatographic oven 527 heats the capillary columns 228, 229 and 231 and the manifold 210 to the desired temperature, while the flow control module 238 remains outside of the oven 527. In this manner, the flow control module 238 is neither exposed to sample gas or high temperatures.

An example of the operation of the fluid multiplexer will be described using the capillary columns 228, 229 and 231, and the detectors 528 and 536. When position 1 on the fluid multiplexer is selected, the fluid multiplexer delivers a blocking flow to all fluid conduits except the fluid conduit 516. This directs the primary flow of the sample to the first column 228 and to the first detector 528 via fluid conduit 529. Clean fluid is directed to all of the other positions on the multiplexer. In this example, clean fluid flows from conduit 518 and column 229 combine with sample-containing flow from column 228 prior to entry into detector 528, but will likely not invoke any response from detector 528. When position 2 on the fluid multiplexer is selected, the fluid multiplexer delivers a blocking flow to all fluid conduits except the fluid conduit 518. This directs the primary flow of the sample to the first detector 528 via fluid conduit 529. Clean fluid is directed to all of the other positions on the multiplexer. In this example, clean fluid flows from column 228 and column 229 combine with sample-containing flow from fluid conduit 518 prior to entry into detector 528, but will likely not invoke any response from detector 528.

When position 3 on the fluid multiplexer is selected, the fluid multiplexer delivers a blocking flow to all fluid conduits except the fluid conduit 522. This directs the primary flow of the sample to the second column 229 and then to the first detector 528 via fluid conduit 529. Clean fluid is directed to all of the other positions on the multiplexer. In this example, clean fluid flow from conduit 518 and column 228 combine with sample-containing flow from column 229 prior to entry into detector 528, but will likely not invoke any response from detector 528. When position 4 on the fluid multiplexer is selected, the fluid multiplexer delivers a blocking flow to all fluid conduits except the fluid conduit 524. This directs the primary flow of the sample to the second detector 536 via fluid conduit 532. Clean fluid is directed to all of the other positions on the multiplexer. In this example, clean fluid flow from column 231 combines with sample-containing flow from fluid conduit 524 prior to entry into detector 536, but will likely not invoke any response from detector 536.

When position 5 on the fluid multiplexer is selected, the fluid multiplexer delivers a blocking flow to all fluid conduits except the fluid conduit 526. This directs the primary flow of the sample to the third column 231 and then to the second detector 536 via fluid connection 532. Clean fluid is directed to all of the other positions on the multiplexer. In this example, clean fluid flow from conduit 524 combines with sample-containing flow from column 231 prior to entry into detector 536, but will likely not invoke any response from detector 536.

Signals from the detectors 528 and 536 are displayed and/or stored digitally and/or recorded mechanically with a plotter to provide a record 534 of the analytical run.

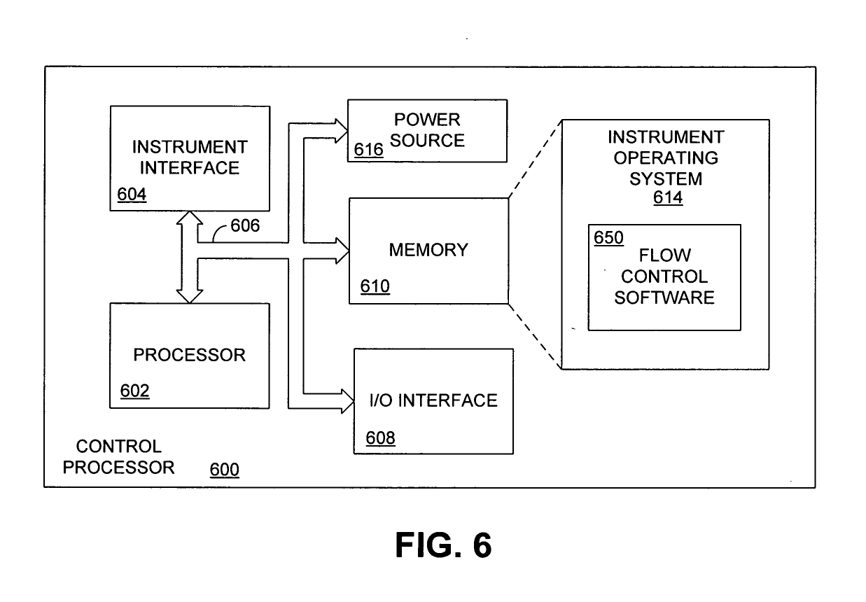

FIG. 6 is a block diagram illustrating an embodiment of the control processor 600 of FIG. 3. The control processor 600 can be any computer based control processor for controlling the operations of the chromatograph 500 of FIG. 5. Further, the control processor 600 may be internal or external to the chromatograph 500. The method of controlling the fluid multiplexer can be implemented in hardware, software, or a combination of hardware and software. When implemented in hardware, the method of controlling the fluid multiplexer can be implemented using specialized hardware elements and logic. When the method of controlling the fluid multiplexer is implemented partially in software, the software portion can be used to control various operating aspects of an analysis device to control the flow of fluid through the analysis device. The software can be stored in a memory and executed by a suitable instruction execution system (microprocessor). The hardware implementation of the method of controlling the fluid multiplexer can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the method of controlling the fluid multiplexer comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

The control processor 600 comprises a processor 602, memory 610, input/output (I/O) interface 608, power source 616 and instrument interface 604 in communication via bus 606. Bus 606, although shown as a single bus, may be implemented using multiple busses connected as necessary among the elements in the control processor 600.

The processor 602 and memory 610 provide the signal timing, processing and storage functions for the control processor 600. The I/O interface generally comprises the input and output mechanisms associated with the control processor 600. For example, the I/O interface 608 may comprise a keyboard, mouse, stylus, pointer, or other input mechanisms. The output portion of the I/O interface 608 may comprise a display, printer, or other output mechanism. The instrument interface 604 comprises the hardware and software used to couple the control processor 600 to the chromatograph 500 to enable communication and control between those elements. The power source 616 may comprise a direct current (DC) or an alternating current (AC) power source.

The memory 610 comprises instrument operating system software 614 and flow control software 650. The instrument operating system software 614 comprises the instructions and executable code for controlling the operation of the chromatograph 500. In one example, the instrument operating system software 614 may be a proprietary operating system. The flow control software 650 is a separate software module that can be integrated into the instrument operating system software 614 or can be implemented independently of the instrument operating system software 614.

The flow control software 650 can be invoked to allow a user of the chromatograph 500 to automatically and independently control the operation of the fluid multiplexer 200 or 400 in the chromatograph 500. In an embodiment, the flow control software 650 is programmed with the physical parameters (such as length and inner diameter of the chromatographic columns) of the components in an analysis device and the parameters of the carrier gas to allow a user to maintain a desired flow in one or more fluid conduits. Further, the flow control software 650 allows accurate and repeatable analysis even of certain parameters of the physical plant of the chromatograph that change over time or from analysis to analysis. For example, changing one of the columns of a chromatograph can change the fluid flow in the system. The physical parameters, e.g., the length and inner diameter, of the new column can be entered into the flow control software 650 so that input and output pressures can be adjusted so that complex analyses can be duplicated, even if one or more components are changed.

In another embodiment, the flow control software 650 can be used for what is referred to as method translation. Method translation refers to changing parameters of an analysis method. One example is doubling the speed of an analysis. By knowing all of the physical parameters of the components in the chromatograph, and by knowing the temperatures and the desired fluid flows, the flow control software 650 can set the input and output pressures of the various fluid conduits so that the speed of analysis can be accurately doubled while maintaining relative retention of sample components.

In another embodiment, the flow control software 650 can be used to adjust the input pressure of a chromatographic column so that the void time (the void time is the time it takes for a non-retained substance to traverse a column) is made the same as in a previous method to ensure that a peak elutes from the column at predictable retention times.

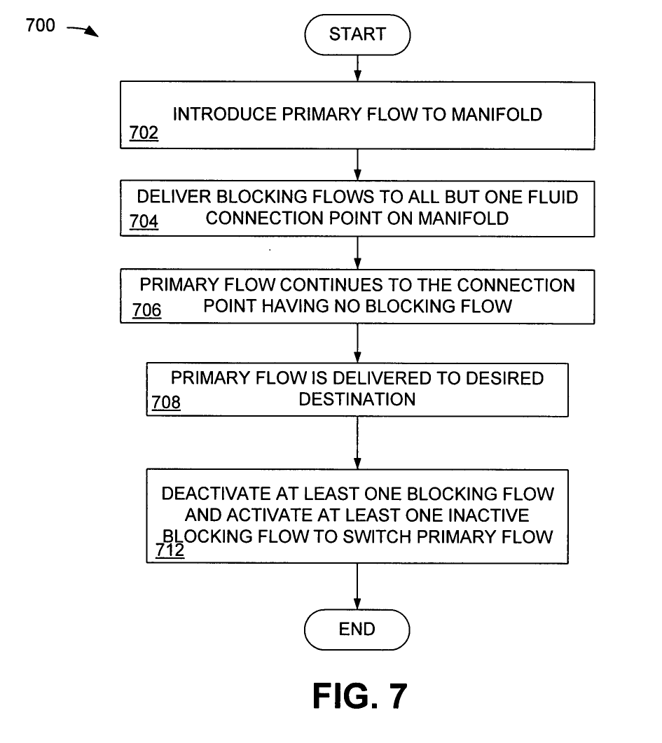

FIG. 7 is a flow chart illustrating the operation of an embodiment of the fluid multiplexer as applied to a chromatographic analysis having a plurality of capillary columns. However, the principles of the fluid multiplexer apply to other fluid systems in which it is desirable to direct a flow of fluid to a number of different destinations. The blocks in the flowchart can be performed in the order shown or out of the order shown, or can be performed in parallel. In block 702, a primary flow is introduced to a manifold. In this example, the primary flow can be a sample gas that is prepared and directed to the manifold 210 as described above. In block 704, a blocking flow of clean carrier gas is delivered to all except one of the fluid connection points on the manifold 210. In block 706, the blocking flows direct the primary flow to the fluid connection point having no blocking flow. In block 708, the primary flow is delivered to the desired destination, which in this example is the capillary column 234. In block 712, at least one of the blocking flows is deactivated and at least one inactive blocking flow is activated to switch the primary flow to a second selected fluid conduit.

The foregoing detailed description has been given for understanding exemplary implementations of the invention and no unnecessary limitations should be understood therefrom as modifications will be obvious to those skilled in the art without departing from the scope of the appended claims and their equivalents. Other devices may use the fluid multiplexer described herein.

What is claimed is:

1. A fluid multiplexer, comprising:
a manifold having a plurality of fluid conduits formed therein;
a primary fluid input and a plurality of controlling fluid connection points located on the manifold and fluidically coupled together via the fluid conduits; and
a flow control module coupled to the controlling fluid connection points, the flow control module configured to provide a plurality of blocking flows to the manifold to control the flow of a primary fluid through the fluid conduits.

2. The fluid multiplexer of claim 1, wherein each one of the plurality of blocking flows corresponds to one of the plurality of fluid conduits and a selected one of the plurality of blocking flows is not active, allowing the primary fluid to flow through the fluid conduit associated with the selected one of the blocking flows that is not active.

3. The fluid multiplexer of claim 2, wherein the manifold further comprises a planar laminate structure in which the fluid conduits are located.

4. The fluid multiplexer of claim 2, wherein the flow control module interacts only with clean carrier fluid.

5. The fluid multiplexer of claim 2, in which the plurality of controlling fluid connection points are coupled to a respective plurality of chromatographic columns.

6. The fluid multiplexer of claim 2, further comprising a vent path associated with each of the plurality of fluid conduits.

7. The fluid multiplexer of claim 6, further comprising a restrictor associated with the vent path.

8. A method for switching fluid flow, comprising
introducing a primary fluid having a primary flow to a manifold having a plurality of fluid conduits formed therein;
providing a plurality of controlling fluid connection points on the manifold;
delivering a plurality of blocking flows to the manifold to direct the primary flow of the primary fluid through a first selected fluid conduit having no blocking flow; and
deactivating at least one of the blocking flows and activating an inactive blocking flow to switch the primary flow to a second selected fluid conduit.

9. The method of claim 8, further comprising providing a blocking flow to all except one of the plurality of controlling fluid connection points on the manifold.

10. The method of claim 9, further comprising forming the manifold using a planar laminate structure.

11. The method of claim 9, further comprising delivering the plurality of blocking flows using a valve that interacts only with clean carrier fluid.

12. The method of claim 9, further comprising coupling a respective plurality of chromatographic columns to the plurality of controlling fluid connection points.

13. The method of claim 9, further comprising providing a vent path associated with each of the plurality of fluid conduits.

14. The method of claim 13, further comprising providing a restrictor associated with the vent path.

15. A fluid multiplexer for controlling flow in a gas chromatograph, comprising:
an inlet;
a manifold coupled to the inlet, the manifold having a plurality of fluid conduits formed therein;
a primary fluid input and a plurality of controlling fluid connection points located on the manifold and fluidically coupled together via the fluid conduits;
a flow control module coupled to the controlling fluid connection points, the flow control module configured to provide a plurality of blocking flows to the manifold to control the flow of a primary fluid through the fluid conduits in which each one of the plurality of blocking flows corresponds to one of the plurality of fluid conduits and a selected one of the plurality of blocking flows is not active causing the primary fluid to flow through the fluid conduit associated with the selected one of the blocking flows that is not active;
a respective plurality of capillary columns coupled to the plurality of controlling fluid connection points; and
at least one detector coupled to at least one of the plurality of capillary columns.

16. The system of claim 15, wherein the manifold further comprises a planar laminate structure in which the fluid conduits are located.

17. The system of claim 16, wherein the flow control module further comprises a valve that interacts only with clean carrier fluid.

18. The system of claim 16, further comprising a vent path associated with each of the plurality of fluid conduits.

19. The system of claim 18, further comprising a restrictor associated with the vent path.

20. The system of claim 18, in which the vent path comprises ablated holes in at least a portion of the fluid conduits in the manifold.
